(19) United States
(12) Patent Application Publication
(10) Pub. No.: US 2026/0134774 A1
(43) Pub. Date: May 14, 2026

(54) SYSTEM AND METHOD FOR INFERRING METRICS OF SIGNALIZED INTERSECTIONS FROM VARIED GPS SOURCES

(71) Applicant: INRIX, Inc., KIRKLAND, WA (US)

(72) Inventors: Nicholas John Burgoyne, Stockport (GB); Bryn John Mills, Wolverhampton (GB); Steve Remias, Kirkland, WA (US); Andrew James Turner, Stockport (GB)

(21) Appl. No.: 18/948,041

(22) Filed: Nov. 14, 2024

(51) Int. Cl. G08G 1/01

(52) U.S. Cl. CPC G08G 1/0125; G08G 1/0108; G08G 1/0145

(57) ABSTRACT

Disclosed is/are system(s) and/or method(s) for providing split failure metrics of signalized traffic intersections by estimating the cycle length of signalized intersections using varied ping frequency data and using the estimated cycle length to estimate the proportion of observed vehicles which have been delayed by the intersection for an amount of time that is larger than the estimated cycle length, and using the delay metric as a replacement for conventional split failure metric.

### BACKGROUND

Roadway intersections that are controlled by traffic signals (signalized intersections) present a control point for traffic authorities to address roadway operations and safety issues and for transportation planners to utilize in determining routes. They provide the ability to allocate traffic delay among conflicting traffic movements and allow for the shared use of roadways. Poorly timed traffic signal system can frustrate drivers and impact congestion, pollution, and safety. However, optimizing their operation (e.g., adjusting the cycle time of traffic signal changes for different movements) is currently a difficult task for traffic engineers and transportation planners for various reasons, including an inability to efficiently obtain needed and relevant information about traffic flows at intersections. One complicating factor is the cost and difficulty to install and maintain hardware at intersections that could potentially provide useful metrics about traffic patterns, on the one hand, or alternatively to manually collect such information (e.g., via in-person collection). Thus, there is a need to provide users such as traffic engineers and planners with new, efficient, and less costly tools and methods for generating traffic pattern information and metrics at signalized intersections.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1A is a flow diagram illustrating an exemplary method of generating traffic pattern information and metrics at signalized intersections, in accordance with one or more embodiments set forth herein.

FIG. 1B is a flow diagram illustrating an exemplary method of generating traffic pattern information and metrics at signalized intersections, in accordance with one or more embodiments set forth herein.

FIG. 2 is a component block diagram illustrating an exemplary system for generating traffic pattern information and metrics at signalized intersections, in accordance with one or more embodiments set forth herein.

FIG. 3 is an illustration of an exemplary user interface displaying split failure information, in accordance with one or more embodiments set forth herein.

FIG. 4 is an illustration of an exemplary computing device-readable medium wherein processor-executable instructions configured to embody one or more of the provisions set forth herein may be comprised.

FIG. 5 is an illustration of an exemplary computing environment wherein one or more of the provisions set forth herein may be implemented.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein.

Rather, example embodiments are provided merely to be illustrative. Such embodiments may, for example, take the form of hardware, software, firmware or any combination thereof.

A number of different Global Navigation Satellite System (GNSS) systems and services operate worldwide, and future GNSS systems may be developed and deployed. For example, regional GNSS systems include: GPS, GLONASS, Galileo, Beidou and other regional systems. The Global Positioning System (GPS) is a GNSS system operated by the United States, although the terms GPS and GNSS may be used interchangeably to refer to any Global Navigation Satellite System, unless context dictates otherwise.

GPS devices are commonly embedded in modern vehicles and hand-held devices. They provide the timestamp-location coordinates of the device during their operation at regular intervals (ping frequency), utilizing satellite signals received from one or more of the various GNSS systems. This information may be used to build data products which monitor the behavior of traffic on roads, such as traffic flow and specific movements at intersections.

Different GPS devices from different providers and/or utilizing different GPS networks may have differing operating characteristics, such as update rate (ping frequency), accuracy, etc. The varied characteristics and quality of such GPS data sources has hindered scaling data products which monitor the behavior of traffic on roads.

As previously noted, an important aspect of traffic flow is the effectiveness of signalized intersections. In general, systems and methods of embodiments disclosed herein may utilize any suitable information and/or metrics to analyze or assist a user in analyzing signalized intersections. Some metrics may include, but are not limited to: average travel time, delay, percentage arrival on green (POG or AoG), split failure rate, etc. Average travel time generally refers to the average time for vehicles to travel through the intersection(s) of interest. Delay generally refers to the additional travel time experienced by vehicles due to the presence of traffic signals at the intersection(s) of interest, including time spent decelerating, stopped, and accelerating. Percentage arrival on green generally refers to the percentage of vehicles at the intersection(s) of interest whose journey is not impeded by the signalized intersection. Split failure rate generally refers to the proportion of queues at the intersection(s) of interest which do not fully discharge during the green phase of the signal.

Traffic metrics such as these can be difficult to calculate and require large amounts of person-hours or infrastructure to estimate without the use of vehicle GPS data; however, even using GPS data in general may present challenges for systems due in part to the disparate and varied use of GPS devices by motorists, yielding GPS data streams that may vary in accuracy and characteristics (e.g., ping frequency), impacting the effectiveness of measuring traffic factors (e.g., vehicle stops) that may be useful in calculating traffic metrics.

The techniques employed by the embodiments disclosed herein overcome such difficulties and efficiently generate more accurate traffic metrics that are resilient to varied GPS data sources. In particular, the techniques employed herein provide systems and methods that can determine and provide split failure metrics and data using varied GPS data sources as described below.

In particular, one or more computing devices, tools and/or techniques for providing split failure metrics of signalized traffic intersections are provided. Applications and services may be configured to generate, utilize and/or display traffic signal analytics on computing devices of users, such as traffic engineers. Some non-limiting examples of such applications and services may include signal optimization, transportation planning, traffic management, traffic modeling, impact analysis, etc. applications and services. These applications and services may be configured to provide split failure metrics as described herein and/or may be configured to access split failure metrics as described herein via a service (e.g., web API), etc.

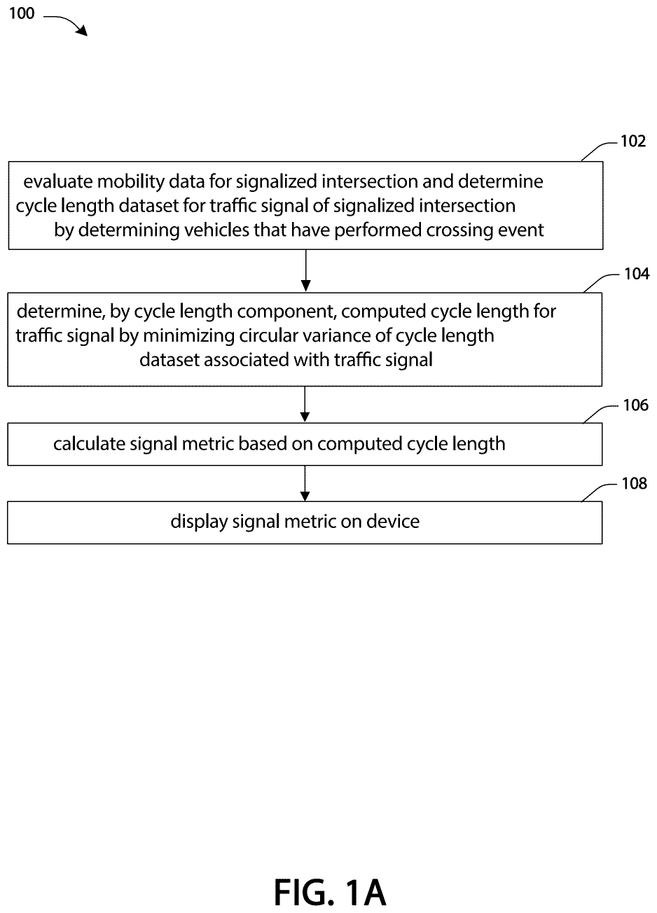

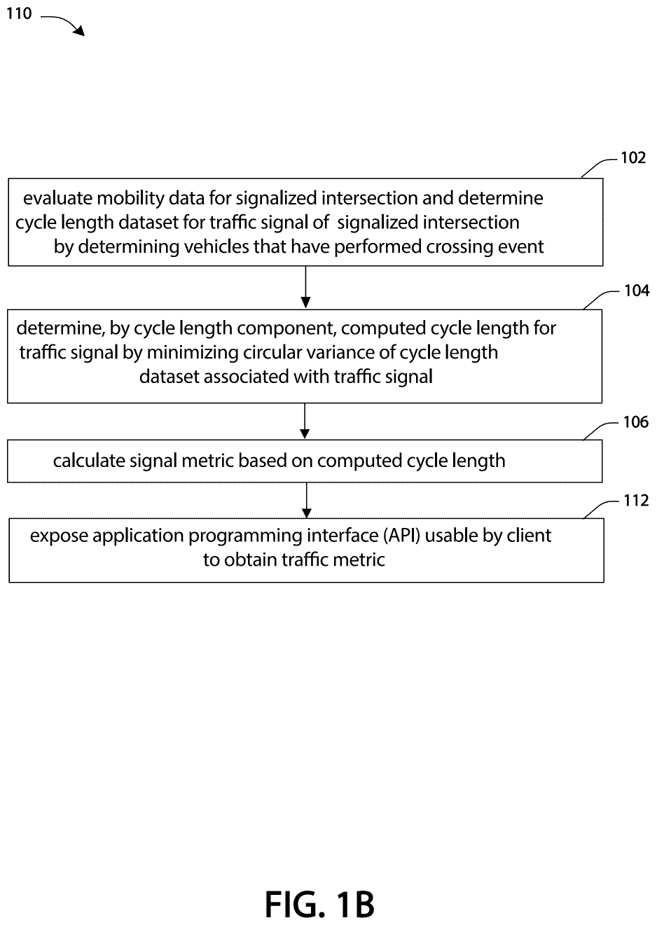

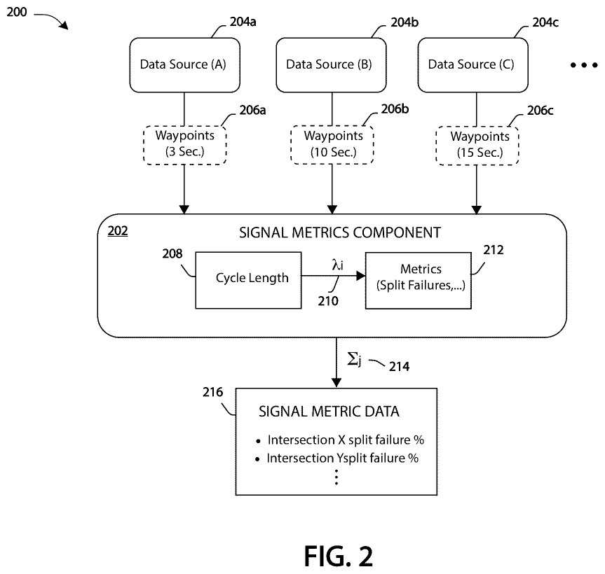

Some embodiments of generating traffic pattern information and metrics at signalized intersections are illustrated by exemplary methods 100 and 110 of FIGS. 1A & 1B, respectively, and are described in conjunction with respect to system 200 of FIG. 2.

System 200 may comprise a signal metrics component 202 comprising software, hardware, and/or a combination thereof. In an embodiment, signal metrics component 202 is hosted by a computing device. The computing device may comprise a server, a virtual machine hosted within a cloud computing environment, etc. Signal metrics component 202 may be comprised of software and/or hardware of the computing device. Signal metrics component 202 may utilize communication functionality of the computing device to access data sources, such as remote computing devices accessible to the computing device over a network. For example, signal metrics component 202 may connect to a data source (A) 204a, a data source (B) 204b, a data source (C) 204c, and/or other data sources over the network.

In general, data sources of the embodiments disclosed herein may generate and/or store, and serve, any suitable traffic data in any suitable manner, sufficient to provide the functionality disclosed herein. In some embodiments, the data sources (e.g., data sources 204) may serve GPS waypoint data based on and/or comprising timestamp-location coordinates of mobility devices at regular intervals (ping frequency). Note that a mobility device as used herein refers to a GPS device that is correlated with a vehicle (e.g., a handheld mobile device present in a vehicle, a vehicle GPS tracker, etc.) in a manner such that the timestamp-location coordinate of the GPS device may be used as a proxy for the timestamp-location coordinate of the vehicle with which it is correlated.

In some embodiments, one or more of the data sources (e.g., data source 204a, 204b and/or 204c) may have different characteristics from one or more of the other connected data sources. For example, in some embodiments, one or more of the data sources may have a first ping frequency, while one or more other connected data sources may have a second ping frequency or a third ping frequency. In the exemplary embodiments shown in FIG. 2, data source 204a may serve or feed GPS waypoint data 206a at a ping frequency of 3 seconds, while data sources 204b and 204c may serve or feed GPS waypoint data 206b and 206c at ping frequencies of 10 seconds and 15 seconds, respectively. Note that the embodiments disclosed herein are not limited to data sources having the exemplary ping frequency rates of FIG. 2, and may generally utilize any GPS waypoint data feeds having ping frequency rates sufficient to calculate a travel time/velocity of a mobility device.

In some embodiments, the signal metrics component (e.g., signal metrics component 202) may comprise a cycle length component 208 and a signal metrics component 212. Cycle length component 208 is configured to determine estimates for the cycle lengths of traffic signals, based on certain mobility device data, as described further below. Cycle length means the period of cyclical signal lights of a traffic signal. For example, in relation to a traffic signal that has a cyclical signal light display of red>green>yellow, the cycle length refers to the span of time needed for the signal light to progress from red to green to yellow and back to red again. Similarly, in relation to a traffic signal that has a cyclical signal light display of red>green, the cycle length refers to the span of time needed for the signal light to progress from red to green and back to red again.

With reference to FIGS. 1A & 1B at 102, in general, accessing mobility data for a given signalized intersection from connected data sources (e.g., data sources 204), the cycle length component (e.g., cycle length component 208) may evaluate the mobility data for the signalized intersection and determine the vehicles that have performed a crossing event there—that is, traversed a measurement line of demarcation configured in the system (the “crossing line”)—and for each of such crossing events, store or otherwise include as part of a cycle length dataset associated with the traffic signal of the signalized intersection, the timestamp of such traversal (the “crossing time” of any such vehicle). It should be understood that the system and methods herein may compile cycle length datasets, and determine metrics based on them, using generally any suitable sampling time windows or buckets (e.g., every hour, every day, etc.) sufficient to provide the functionality disclosed herein. In other embodiments, another component (not shown) may perform the mobility data evaluation and determine the crossing events and make available the cycle length dataset (e.g., the timestamp information) to the cycle length component.

The crossing line may comprise generally any line of measurement that is approximately normal to the line of traffic that is controlled by the intersection signal light being evaluated. For example, in some embodiments the crossing line for a given traffic signal may be the stop bar (i.e., the queueing start line as demarcated by local traffic authorities). In other embodiments, the crossing line may be a line parallel and offset from the stop bar.

At 104, the cycle length component may determine a computed cycle length for the traffic signal. In some embodiments, the cycle length component (e.g., component 208) may determine the computed cycle length (e.g., computed cycle length 210 in FIG. 2) based on minimizing the circular variance of the cycle length dataset associated with the traffic signal. That is, the cycle length component may determine (via, e.g., iteration) a time span that, when selected as the circular scale for plotting the cycle length dataset, results in a minimum circular variance as compared to a different time span. Without wishing to be bound by theory, circular plotting of the cycle length dataset should always have minimum variance when the scale of the plot matches the cycle length because the traffic passing the crossing line should be zero or close to zero vehicles during a portion of the dataset (e.g., the red-light portion of the cycle length) when the scale matches the cycle length.

In some embodiments, the cycle length component may determine the computed cycle length as follows. First, crossing times are converted to angles for a given cycle length, l, by using the formula:

$${θ}_{l} = 2 π ( \frac{t mod l}{l} ) \qquad ( 1 )$$

for all cycle lengths l, where t is the crossing time and t mod lis the remainder after dividing t by l. Then, the average vector pₗ and length Rₗ are calculated as

$${p}_{l} = ( \frac{1}{n} {\sum }_{{θ}_{l}} cos ( {θ}_{l )} , \frac{1}{n} {\sum }_{{θ}_{l}} sin ( {θ}_{l} ) ) , {R}_{l} = \vert {p}_{l} \vert \qquad ( 2 )$$

where the sum is over probe (vehicle) crossing times and n is the number of probes. Next, the circular mean is calculated as

$${μ}_{l} = arg ( {p}_{l} ) \qquad ( 3 )$$

and circular variance is calculated as

$${σ}_{l} = 1 - {R}_{l} \qquad ( 4 )$$

Finally, the cycle length may be determined such that

$$L = arg {min}_{l} \{ 1 - {R}_{l} \} \qquad ( 5 )$$

That is, the length l which minimizes circular variance may be determined to be the true cycle length.

As may be appreciated, since the cycle length determination of the embodiments disclosed herein relies on vehicle travel time data and/or metrics (e.g. travel time, control delay), and does not rely on identifying more granular traffic artifacts (e.g., stops), the system and methods disclosed herein may utilize mobile data from various sources, including those having relatively long ping frequency, that may not otherwise provide enough granularity to be utilized in other signal metrics systems and methods. The ability to rely on diverse data sources allows the embodiments disclosed herein to be more scalable than other types of signal metrics systems and methods.

Referring again to FIG. 2, the signal metrics component (e.g. component 202) may comprise a metric calculator component (e.g., component 212) that calculates at least one signal metric based on the computed cycle length (e.g., computed cycle length 210). With reference to FIGS. 1A & 1B, at 106 the system (e.g., component 212) may calculate a signal metric based on the computed cycle length calculated at 104 (e.g., computed cycle length 210).

In one or more embodiments, the signal metric may comprise a split failure metric. As previously described, a split failure refers to a traffic queue at a signal that does not fully discharge during the green phase of the signal. In general, the split failure metric calculated by the embodiments herein (e.g., split failure metric 214 of FIG. 2) comprises, for a mobility device associated with a vehicle, a classification whether a measured travel time indicator (e.g., control delay, computed by subtracting the crossing time by the entry time and then again by the traversal time to the stop bar) for the mobility device (i.e., for the vehicle) through a signalized intersection is greater than the computed cycle length (e.g., computed cycle length 210) for the traffic signal for the intersection that controls the traffic pattern along which the vehicle is traveling. A measured travel time indicator (e.g., control delay)—that is greater than the computed cycle length may be classified by the embodiments herein as a split failure instance for the traffic signal.

In some embodiments, the signal metric may comprise an aggregate of one or more other signal metrics. For example, in some embodiments, the system (e.g., system 200) may continuously or periodically (in sampling windows) calculate split failures (e.g., signal metrics 214) as described above and calculate or generate a rate of split failures and store and report the rate as a signal metric, as represented by signal metrics 216 in FIG. 2. In general, the rate of split failures may be calculated in any suitable manner sufficient to provide a meaningful indicator of relative split failure magnitude of a traffic signal. For example, in some embodiments the rate of split failures may be calculated by scoring any vehicle traveling through a signalized intersection whose measure travel time indicator (e.g., control delay) does not exceed the computed cycle length for the relevant traffic signal as zero and scoring those whose travel time does exceed the computed cycle length for the traffic signal as one, and summing the number of vehicles whose control delay exceeded the cycle length divided by the total number of vehicles and calculating the ratio of the two, etc.

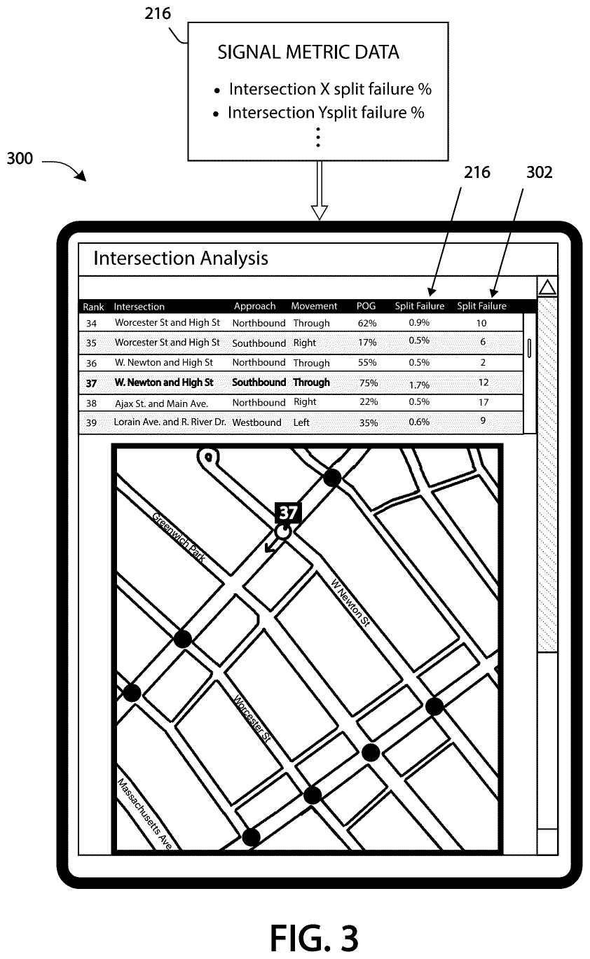

In some embodiments, at 108 (FIG. 1A), the calculated signal metric may be displayed on a display of a device. For example, with reference to FIG. 3, system 200 may comprise a user interface, such as a graphical user interface 300. In one or more embodiments, the user interface may be provided by one or more front end applications and/or applications having front end components. Such front-end applications and/or components may be tightly or loosely coupled with one or more backend applications and/or components, such as signal metrics component 202. Generally any suitable application architecture sufficient to provide the functionality disclosed herein may be employed in the embodiments.

With continuing reference to FIG. 3, it may be seen that one or more split failure metrics, such as aggregate split failure rates 216, may be displayed on user interface 300, as well as other split failure metrics (e.g., aggregate split failures 302).

With reference to FIG. 1B, instead of or in addition to displaying the calculated signal metric on the display of a tightly or loosely couple front end/device at 112, in some embodiments the system (e.g., system 200) may expose an application programming interface (API) usable by a client, such as a front-end user interface client or client application, automated traffic control systems, smart traffic signal controllers, etc.

Implementation of at least some of the disclosed subject matter may lead to benefits including, but not limited to, better management of traffic systems, better response times for traffic managers, more accurate metrics, more scalable systems, less costly generation of traffic signal metrics, etc.

Alternatively and/or additionally, implementation of at least some of the disclosed subject matter may lead to benefits including improved usability of mobility-related data.

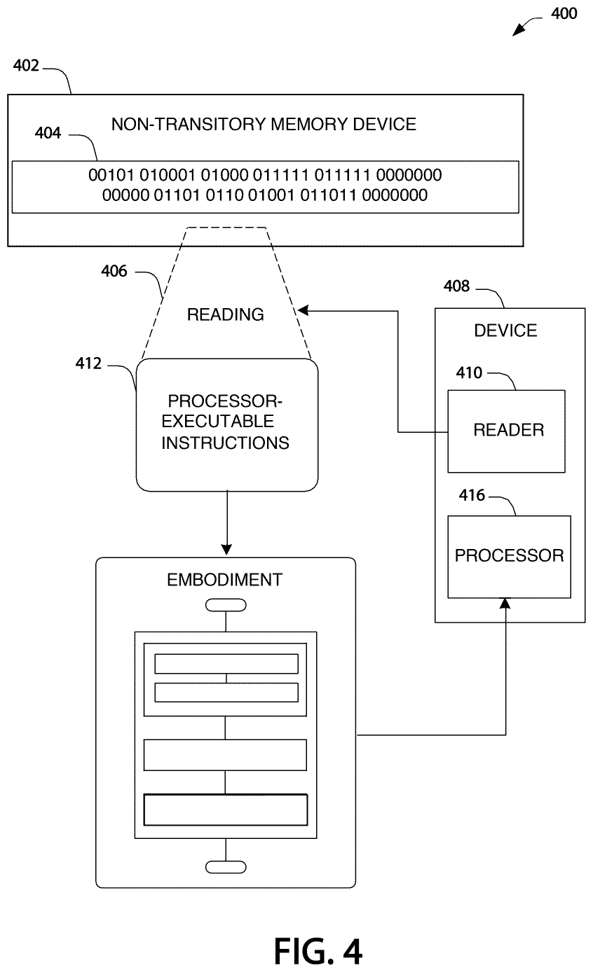

FIG. 4 is an illustration of a scenario 400 involving an example non-transitory machine readable medium 402. The non-transitory machine readable medium 402 may comprise processor-executable instructions 412 that when executed by a processor 416 cause performance (e.g., by the processor 416) of at least some of the provisions herein. The non-transitory machine readable medium 402 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine readable medium 402 stores computer-readable data 404 that, when subjected to reading 406 by a reader 410 of a device 408 (e.g., a read head of a hard disk drive, or a read operation invoked on a solid-state storage device), express the processor-executable instructions 412. In some embodiments, the processor-executable instructions 412, when executed cause performance of operations, such as at least some of the example method 100, 110 of FIGS. 1A & 1B, for example. In some embodiments, the processor-executable instructions 412 are configured to cause implementation of a system, such as at least some of the example system 200 of FIG. 2, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

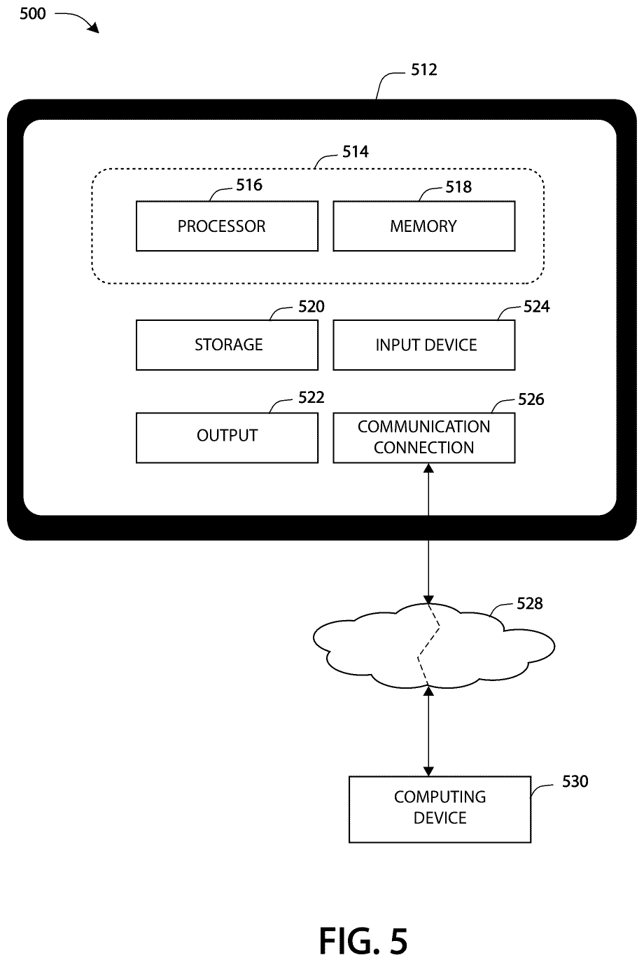

FIG. 5 and the following discussion provide a brief, general description of a suitable computing environment to implement embodiments of one or more of the provisions set forth herein. The operating environment of FIG. 5 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 5 illustrates an example of a system 500 comprising a computing device 512 configured to implement one or more embodiments provided herein. In one configuration, computing device 512 includes at least one processor 516 and memory 518. Depending on the exact configuration and type of computing device, memory 518 may be volatile (such as RAM, for example), non-volatile (such as ROM, flash memory, etc., for example) or some combination of the two. This configuration is illustrated in FIG. 5 by dashed line 514.

In other embodiments, device 512 may include additional features and/or functionality. For example, device 512 may also include additional storage (e.g., removable and/or non-removable) including, but not limited to, magnetic storage, optical storage, and the like. Such additional storage is illustrated in FIG. 5 by storage 520. In one embodiment, computer readable instructions to implement one or more embodiments provided herein may be in storage 520. Storage 520 may also store other computer readable instructions to implement an operating system, an application program, and the like. Computer readable instructions may be loaded in memory 518 for execution by processor 516, for example.

The term “computer readable media” as used herein includes computer storage media. Computer storage media includes volatile and nonvolatile, removable and non-removable media implemented in any method or technology for storage of information such as computer readable instructions or other data.

Memory 518 and storage 520 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 512. Computer storage media does not, however, include propagated signals. Rather, computer storage media excludes propagated signals. Any such computer storage media may be part of device 512.

Device 512 may also include communication connection 526 that allows device 512 to communicate with other devices. Communication connection 526 may include, but is not limited to, a modem, a Network Interface Card (NIC), an integrated network interface, a radio frequency transmitter/receiver, an infrared port, a USB connection, or other interfaces for connecting computing device 512 to other computing devices. Communication connection 526 may include a wired connection or a wireless connection.

Communication connection 526 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 512 may include input device 524 such as keyboard, mouse, pen, voice input device, touch input device, infrared cameras, video input devices, and/or any other input device. Output device 522 such as one or more displays, speakers, printers, and/or any other output device may also be included in device 512. Input device 524 and output device 522 may be connected to device 512 via a wired connection, wireless connection, or any combination thereof. In one embodiment, an input device or an output device from another computing device may be used as input device 524 or output device 522 for computing device 512.

Components of computing device 512 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 512 may be interconnected by a network. For example, memory 518 may be comprised of multiple physical memory units located in different physical locations interconnected by a network.

Those skilled in the art will realize that storage devices utilized to store computer readable instructions may be distributed across a network. For example, a computing device 530 accessible via a network 528 may store computer readable instructions to implement one or more embodiments provided herein. Computing device 512 may access computing device 530 and download a part or all of the computer readable instructions for execution. Alternatively, computing device 512 may download pieces of the computer readable instructions, as needed, or some instructions may be executed at computing device 512 and some at computing device 530.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc.

For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above-described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method involving a computing device comprising a processor, and the method comprising:
executing, on the processor, instructions that cause the computing device to perform operations, the operations comprising:
evaluating mobility data for a traffic intersection having a traffic signal and determining a cycle length dataset associated with the traffic signal;
determining, by a cycle length component, a computed cycle length for the traffic signal by minimizing the circular variance of the cycle length dataset associated with the traffic signal;
calculating a signal metric based on the computed cycle length; and
displaying the signal metric on a display of a device.

2. The method of claim 1, wherein the mobility data comprises GPS waypoint data of mobility devices served by multiple data sources.

3. The method of claim 2, wherein the mobility data served by multiple data sources comprises GPS waypoint data served at multiple different ping frequencies.

4. The method of claim 1, wherein determining the cycle length dataset associated with the traffic signal comprises determining vehicles that have performed a crossing event and including in the cycle length dataset, for each of such crossing events, the timestamp of the crossing event.

5. The method of claim 1, wherein the signal metric comprises a split failure count.

6. The method of claim 1, wherein the signal metric comprises a split failure rate.

7. The method of claim 6, wherein the displaying comprises including the signal metric in the display of a graphical user interface executing on the device.

8. A method involving a computing device comprising a processor, and the method comprising:
executing, on the processor, instructions that cause the computing device to perform operations, the operations comprising:
evaluating mobility data for a traffic intersection having a traffic signal and determining a cycle length dataset associated with the traffic signal;
determining, by a cycle length component, a computed cycle length for the traffic signal by minimizing the circular variance of the cycle length dataset associated with the traffic signal;
calculating a signal metric based on the computed cycle length; and
exposing an application programming interface (API) usable by a client to obtain the traffic metric.

9. The method of claim 8, wherein the mobility data comprises GPS waypoint data of mobility devices served by multiple data sources.

10. The method of claim 9, wherein the mobility data served by the multiple data sources comprises GPS waypoint data served at multiple different ping frequencies.

11. The method of claim 8, wherein determining the cycle length dataset associated with the traffic signal comprises determining vehicles that have performed a crossing event and including in the cycle length dataset, for each of such crossing events, the timestamp of the crossing event.

12. The method of claim 8, wherein the signal metric comprises a split failure count.

13. The method of claim 8, wherein the signal metric comprises a split failure rate.

14. The method of claim 13, wherein the client comprises a front-end user interface, an automated traffic control system, or a smart traffic signal controller.

15. A non-transitory machine-readable medium having stored thereon processor-executable instructions that when executed cause performance of operations, the operations comprising:
evaluating mobility data for a traffic intersection having a traffic signal and determining a cycle length dataset associated with the traffic signal;
determining, by a cycle length component, a computed cycle length for the traffic signal by minimizing the circular variance of the cycle length dataset associated with the traffic signal;
calculating a signal metric based on the computed cycle length; and
displaying the signal metric on a display of a device.

16. The method of claim 15, wherein the mobility data comprises GPS waypoint data of mobility devices served by multiple data sources.

17. The method of claim 16, wherein the mobility data served by the multiple data sources comprises GPS waypoint data served at multiple different ping frequencies.

18. The method of claim 15, wherein determining the cycle length dataset associated with the traffic signal comprises determining vehicles that have performed a crossing event and including in the cycle length dataset, for each of such crossing events, the timestamp of the crossing event.

19. The method of claim 15, wherein the signal metric comprises a split failure rate.

20. The method of claim 19, wherein the displaying comprises including the signal metric in the display of a graphical user interface executing on the device.
